(19) United States
(12) Patent Application Publication
(10) Pub. No.: US 2014/0109773 A1
(43) Pub. Date: Apr. 24, 2014

(54) DEVICE FOR ROASTING CORN ON COB

(71) Applicant: Bipin Prabhakar Deshpande, Pune (IN)

(72) Inventor: Bipin Prabhakar Deshpande, Pune (IN)

(21) Appl. No.: 14/118,896

(22) PCT Filed: Jun. 21, 2012
(86) PCT No.: PCT/IN2012/000443

§ 371 Date: Nov. 20, 2013

(30) Foreign Application Priority Data
Jun. 22, 2011 (IN) 1815/MUM/2011

(51) Int. Cl. A47J 36/32

(52) U.S. Cl. CPC A47J 36/32
USPC 99/327

(57) ABSTRACT

The present invention provides a device for roasting food, especially corn-on-cob. The said device comprises one or more cylindrical heating chamber adapted in a housing for roasting a corn-on-cob electrically, a holding means to hold the corn-on-cob inside the heating chamber, and a controller means for controlling heating and setting a time duration for roasting the corn-on-cob in the chamber. The corn-on-cob gets roasted evenly as it is surrounded by the heating chamber. The roasting device can be used for other foods also.

### FIELD OF INVENTION

The present invention relates to a device for roasting food especially corn-on-cob.

### BACKGROUND ART

Corn is a popular high-fiber, calorie-rich snack, all over the world. Popular cooking methods generally used are separating corns/seeds from a cob and then boiling or steaming and roasting corns on cob directly.

Roasted corn-on-cob, is usually achieved through roasting on a grill and is a popular item for barbecues. To grill a corn-on-cob, in one method the corn-on-cob is soaked in water without removal of husk and silk from the corn-on-cob and then place over the grill and turning the corn-on-cob over the grill. In another method which is traditional method popular in. India, the husk along with silk is removed from the corn and roasting over a burning charcoal. In one another method, the peeled corn-on-cob is wrapped with aluminum foil and then roasted. After roasting, husk and silk are removed if the corn-on-cob is roasted with husk, the corn-on-cob is served for eating by applying lemon juice or butter and some salts and/or pepper or chili powder. However, generally roasting takes up to 20 min depending on method of heating.

Further, turning of cob is required for roasting of all the sides of the corn. Moreover, in some cases, due to unidirectional and uneven heating (due to limitations of the physical dimensions of the heating area), it requires the constant attention of an operator, to ensure adequate and uniform roasting. It also requires a ‘set up’ time to ensure that the grill is adequately heated. Further, smoke is generated if charcoal is used for roasting.

Now, there have been some devices like oven available for domestic use for roasting corn-on-cob. However, they have suffered from various drawbacks. In some cases, they are relatively expensive. In others, they have involved complex operations and may require high degree of operator training and expertise.

A Utility Model DE 20316750 U1 discloses a Roasting device comprising a housing containing a roasting basket connected to a rotary drive, an electrical heating arrangement extending over part of the periphery of the basket and over the height of the basket, and a timer connected to the drive and the heating arrangement. However, said device is complicated and uses a rotating basket for rotating the corn cob and the electrical heating coils arranged at one side of the rotating basket which heat/roasts the corn cob at one side therefore requires more time to roast the corn cob and may consumes more electricity. Further it may fail to provide uniform roasting of corn-on-cob.

### SUMMARY OF THE INVENTION

Accordingly, an object of the present invention is to provide a simple electrically powered device for roasting corn-on-cob that substantially obviates one or more problems or disadvantages of the related art.

Another object of the present invention is to provide device for roasting corn-on-cob that allows roasting of corn-on-cob at home also.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

Accordingly, the present invention provides a device for roasting food, especially corn-on-cob, comprising a housing, at least one cylindrical heating chamber adapted in the housing for roasting a corn-on-cob, a holding means for each heating chamber for holding the corn-on-cob inside the heating chamber, and a controller means for controlling heating and/or setting a roasting time duration for roasting the corn-on-cob in the heating chamber.

According to one embodiment of the present invention, the device also comprises a temperature sensing means for sensing the temperature of heating chamber and a selector means for selecting a desired set point temperature to select a degree of browning of corn-on-cob.

According to an embodiment of the present invention, the holding means can be adapted fixedly or removably. The holding means can be a basket, a cage, or any other suitable means for preventing short-circuit/fusing of the heating element, or uneven burning of the corn-on-cob, or igniting the corn-on-cob due to direct contact. According to the present invention, the device may comprise of a pop-up means to raise the holding means with the roasted corn-on-cob when roasting time of the corn-on-cob set by the user is completed or a manually operated lever to raise the holding means with the roasted corn-on-cob.

According to the present invention, the heating chamber comprises a heating element adapted inside an insulating chamber. The heating element can be wound, embedded, placed or wrapped inside the heating chamber evenly or at varying density by various methods including circular, spiral, helical, vertical, single or multi-layered. According to an embodiment. the heating element can be wrapped inside an electrical insulating material including mica and adapted inside the insulating chamber. According to the present invention, the heating element can be made of nichrome, quartz IR, heating coils, strips, etc. According to the present invention, the insulating chamber can be made of ceramic, cement, or any other suitable electrical and/or thermal insulating material.

According to an alternative embodiment of the present invention, the heating chambers may comprise one or more heating zones.

According an embodiment of the present invention, the heating chamber may comprise a reflective surface for reflecting radiant heat. Alternatively, the inside surface of the insulating chamber can be a reflective.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a cross-sectional view of the device for roasting corn-on-cob of one embodiment according to the present invention;

FIG. 2 shows a top plan view of a device for roasting corn-on-cob shown in FIG. 1 along with a corn-on-cob;

FIG. 3 shows a roasting device according to another embodiment of the invention; and

FIG. 4 shows a roasting device according to further another embodiment of the invention.

### DETAILED DESCRIPTION OF THE INVENTION

In general, the present invention provides a device for roasting food, especially corn-on-cob. The said device comprises one or more cylindrical heating chamber adapted in a housing for roasting a corn-on-cob electrically, a holding means to hold the corn-on-cob inside the heating chamber, and a controller means for controlling heating and setting a time duration for roasting the corn-on-cob in the chamber wherein the corn-on-cob is roasted evenly as it is surrounded by the heating chamber.

Reference will now be made in detail to the preferred embodiments of the present invention, examples of which are illustrated in the accompanying drawings. Wherever possible, the same reference numbers will be used throughout the drawings to refer to the same or like parts.

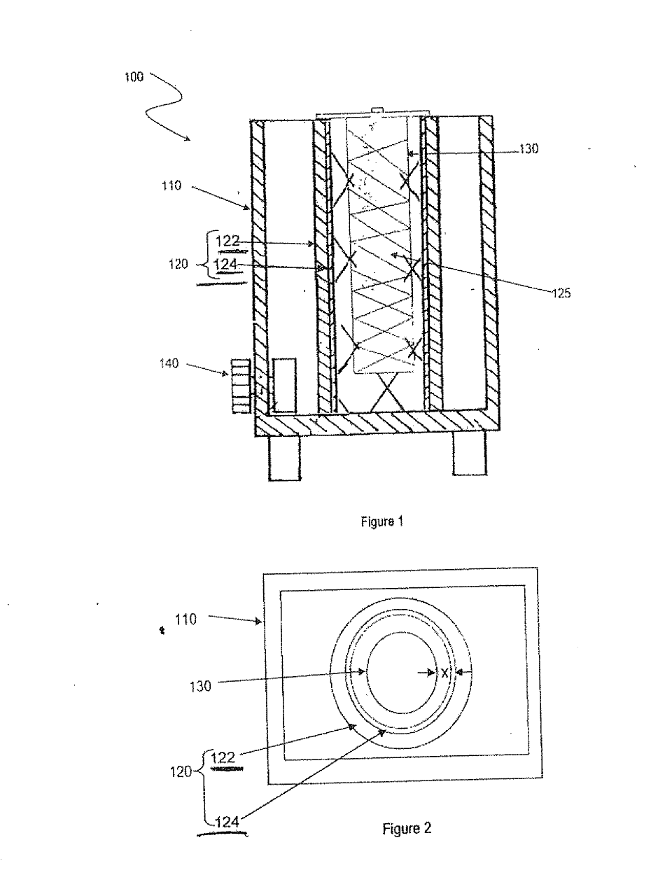

Referring FIGS. 1 to 4 show one of the preferred embodiment of a corn-on-cob roasting device (100, 200, 300) according to the present invention to roast one corn-on-cob at a time. As shown in FIGS. 1 and 2, the corn-on-cob device comprises a housing (110), a cylindrical heating chamber (120) for roasting a corn-on-cob, a holding means (130) to hold the corn-on-cob inside the heating chamber (120), and a controller means (140) for controlling heating and setting a time duration for roasting the corn-on-cob in the chamber.

The housing (100) shown in FIGS. 1 and 2 is a rectangular shape. Alternatively, the housing can be of any shape and size with an aesthetic look. It can be made of any suitable plastic, metal or composite material, or a combination.

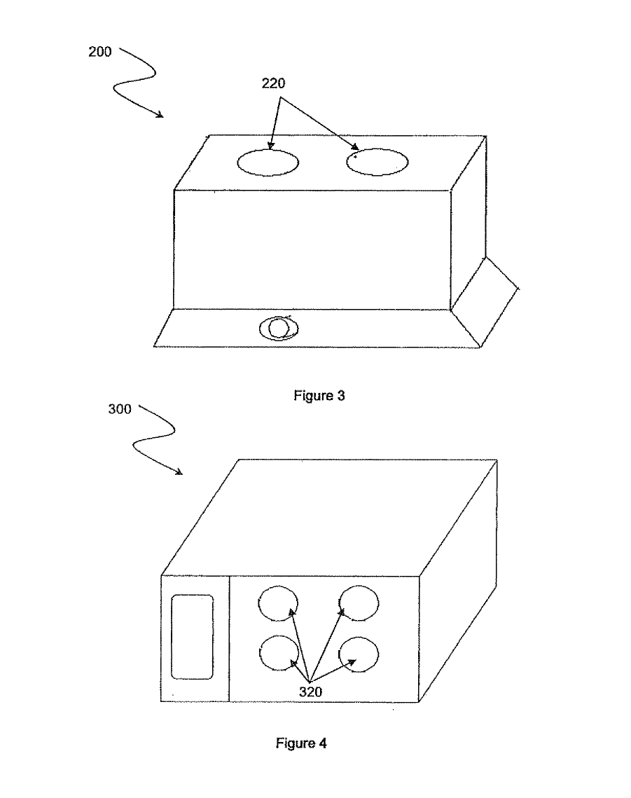

The corn-on-cob roasting device as shown in FIGS. 1 and 2 comprises one cylindrical heating chamber (120). Alternatitevely, the device can comprise of any number of heating chambers. FIGS. 3 and 4 shows the corn-on-cob roasting device (200, 300) having two and four heating chambers (220, 320) respectively.

The heating chambers (120,220) shown in the FIGS. 1-3 has a circular cross sectional shape and adapted vertically in the housing. In the roasting device (100) as shown in FIG. 1, the corn-on-cob can be inserted from top. According to the present invention the heating chamber can have tubular or conical shape with circular or any polygonal cross-sectional shape including hexagonal, octagonal, etc. According to the present invention, the heating chamber can be adapted slantingly or in horizontal positions also. The roasting device (300) as shown in FIG. 4 comprises four horizontal heating chambers (320). It could be designed to stand on a flat surface such as a table or shelf or also be designed to be mounted on a kitchen or other wall.

The heating chamber (120) comprises a heating element (not shown) adapted in an insulating material (not shown). The heating chamber may comprise of a reflective surface for reflecting radiant heat or inside surface of the insulating chamber of the heating chamber may be reflective. The heating element can be wound, embedded, placed or wrapped inside the insulating chamber evenly or varying density by various methods including circular, spiral, helical, vertical, single or multi-layered. According to the present invention, the heating element can be made of nichrome, quartz IR, heating coils, strips, etc. According to the present invention, the insulating chamber can be made of mica, ceramic, cement, or any other suitable electrical and/or thermal insulating material. Alternatively, the heating element can be wrapped from outside to a cylinder made of a heat conductive material. The heating chambers can be divided in one or more heating zones to utilize the heating element depending on the length of the corn-on-cob. The person skilled in the art can easily understand manufacturing of the heating chamber after reading the disclosure of the present invention and does not require further detailed information.

The holding means (130) shown in the FIG. 2 is a basket, a cage, or any other suitable means for preventing direct contact of the corn-on-cob with the inside surface of the heating chamber. The holding means can be made of metal or any known means which will be able to withstand the heat generated within the heating chamber. The shape of the basket or cage can be conical, straight, etc. The holding means maintains a sufficient distance (x) from the heating element as shown in FIG. 2 for avoiding direct contact of the corn-on-cob with the heating element of the heating chamber to prevent short circuit/fusing of the heating element, or uneven burning of the corn-on-cob, or igniting the corn-on-cob due to direct contact.

The controller (140) according to the present invention allows the user to adjust a time duration for roasting the corn-on-cob as per his/her wish. The controller of the roasting device of the present invention may comprise of a temperature sensing means for sensing the temperature of heating chamber to select a degree of browning of corn-on-cob and a selector means for manually adjusting to select a desired set point temperature. The temperatures of heating chamber are adjustable over a range substantially equal to 50° C.-1200° C.

According to the present invention, the roasting device may comprises a removable tray (not shown) to cover bottom of the heating chamber. The tray is provided for reducing heat loss as well as for easy cleaning the device. The person skilled in the art can easily understand how to provide a tray after reading the disclosure of the present invention and does not require detailed information.

According to further embodiment of the present invention, the roasting device may comprise of a pop-up means to raise the holding means with the roasted corn-on-cob when roasting time set by the user is completed or a or manually operated lever to raise the holding means with the roasted corn-on-cob . The pop-up arrangement is very well known and not required to be discussed in detailed with figures.

According to the inventor of the present invention, the roasting device consumes 100 W to 2 KW (100 W to 2 KW) electricity and require 5-15 Amperes current to generate a temperature substantially equal to 50° C.-1200° C. The device can be operated on AC/DC supply.

The roasting device of the present invention can be combined with a bread slice toaster or any other conventional barbecue/roasting/cooking system and home appliances including mixer, grinder and the like.

According to the present invention, the corn-on-cob (125) to be roasted is inserted in the cage/basket from top in the roasting device (100) as shown in FIG. 1. The corn-on-cob (125) shown in FIG. 1 is required to be inserted in the device without husk and silk. As per the user requirements, the controller means and temperature can be adjusted and corn-on-cob is roasted in the heating chamber. The corn-on-cob gets roasted within 0.5-5 minutes with the help of the roasting device of the present invention. In the present invention, turning of the corn-on-cob is not required as in the traditional system since the heating element surrounds the corn-on-cob and the corn gets roasted evenly. The corn-on-cob can be adapted vertically upside down or right side up also and horizontally and even slanting also by adapting the heating chamber in the housing accordingly.

The roasting device of the present invention can be used to roast other food items also including fish, meat items, potatoes onions, brinjals etc. The roasting device of the present invention allows the user to roast a corn-on-cob at home.

Further, the roasting device of the present invention is safe as there are no (unmarked) external ‘hot’ points, flames, etc and easy enough for even children to operate. Further, if the corn-on-cob burns in the heating chambers, the thermal insulation would prevent any other part of the housing to catch fire. The device is compact and can be used outdoors or indoors use. It is smoke free as the electrical heating mechanism does not generate any smoke. It is hygienic as human handling and outdoors cooking using fuels such as coal or wood is eliminated.

The inventive concept of the present invention is to roast the corn-on-cob evenly by providing heating element surrounding the corn-on-cob. It will be apparent to those skilled in the art that various modifications and variations such as providing display panel for controlling roasting operations, a ‘defrost’ option in case the corn on cob has been kept in cold storage etc. and various modifications in the heating chambers as well as controller can be made in the present invention without departing from the spirit or scope of the inventions which is nothing but to roast a corn-on-cob evenly without turning while roasting. Further, the term ‘density of the heating element’ means number of the windings per unit length. The nouns such as top, bottom etc. are used for the sake of understanding and does not limit the invention if the heating chambers is adapted horizontally/slantingly in the housing. The electrical connections and electronics of the device are not shown as person skilled in the art can easily understand and provide the same. Thus, it is intended that the present invention covers the modifications and variations of this invention provided they come within the scope of the appended claims and their equivalents.

1. A device for roasting food, especially corn-on-cob, comprising a housing;
at least one cylindrical heating chamber adapted in the housing for roasting a corn-on-cob;
a holding means for each heating chamber for holding the corn-on-cob inside the heating chamber; and
a controller means for controlling heating and/or setting a roasting time duration for 10 roasting the corn-on-cob in the chamber.

2. The device as claimed in claim 1 further comprises a tray adapted removably to cover from bottom of the cylindrical heating chamber.

3. The device as claimed in claim 1 further comprises a temperature sensing means for sensing the temperature of heating chamber and a selector means for selecting a desired set point temperature to select a degree of browning of corn-on-cob.

4. The device as claimed in claim 1, wherein the temperatures of heating chamber 20 are adjustable over a range substantially equal to 50° C.-1200° C.

5. The device as claimed in claim 1, wherein the holding means can be adapted fixedly or removably.

6. The device as claimed in claim 1, wherein the holding means is a basket, a cage or any other suitable means.

7. The device as claimed in claim 1, wherein the electrical heating element adapted inside an insulating layer with reflective surface for reflecting radiant heat

8. The device as claimed in claim 1, wherein the heating element can be wound, embedded, placed or wrapped inside the insulating chamber evenly or at varying density by various method including circular, spiral, helical, vertical, single or multi-layered or can be adapted in an electrical insulation like mica.

9. The device as claimed in claim 1, wherein the heating element made of nichrome, quartz IR, heating coils, strips, etc.

10. The device as claimed in claim 7, wherein insulating layer can be made of ceramic, cement, or any other suitable electrical and/or thermal insulating material .

11. The device as claimed in claim 7, wherein the heating chambers can be divided into heating zones.

12. The device as claimed in claim 1, wherein the heating chamber can be adapted vertically, horizontally or slantingly in the housing.

13. The device as claimed in claim 1, wherein the cylindrical heating chamber has tubular or conical shape with circular or any polygonal cross-sectional shape including hexagonal, octagonal, etc.

14. The device as claimed in claim 1 further comprises a pop-up means to raise the holding means with the roasted corn-on-cob when roasting time of the corn-on cob set by the user is completed or a manually operated lever to raise the holding means with the roasted corn-on-cob.

15. The device as claimed in claim 1 wherein the device can be operated on AC/DC supply.

16. The device as claimed in claim 1, wherein the electrical heating element adapted inside an insulting layer without reflective surface.
